(19) United States
(12) Patent Application Publication
(10) Pub. No.: US 2010/0230443 A1
(43) Pub. Date: Sep. 16, 2010

(54) LOTION PUMP WITH AN EXTERNALLY INSTALLED SPRING

(76) Inventor: Yaowu Ding, Taixing (CN)

Correspondence Address: HAMRE, SCHUMANN, MUELLER & LARSON, P.C., P.O. BOX 2902, MINNEAPOLIS, MN, 55402-0902, US

(21) Appl. No.: 12/303,780

(22) PCT Filed: Sep. 7, 2006
(86) PCT No.: PCT/CN2006/002318

§ 371 Date: Dec. 8, 2008

(30) Foreign Application Priority Data
Jun. 15, 2006 (CN) 200610027850.6

(51) Int. Cl. G01F 11/00; B65D 88/54

(52) U.S. Cl. 222/321.9; 222/340

(57) ABSTRACT

The present invention provides a lotion pump, comprises: a nozzle head; a connecting/guiding member connected to the nozzle head, in which an upper one-way valve is disposed; a container cap having a first connection structure and a second connection structure, said first connection structure is to engage with a mouth of a bottle; a housing, on its upper end, there is a connection structure engaging with the second connection structure on the container cap, and on its lower end, there is a lower one-way valve; a piston which moves within the housing, its upper end is connected to the connecting/guiding member; and a spring which makes the piston return; characterized in that, the upper end of the spring abuts against the connecting/guiding member, the lower end of the spring abuts against a spring seat which is provided in the housing. The lotion pump with an externally installed spring of the present invention does not make the spring contact the lotion, and is realized with a very simply structure, less parts, thereby the productivity can be notably increased and the manufacturing cost can be greatly reduced.

### TECHNICAL FIELD

The present invention relates to a lotion pump used in the fields of chemical articles for daily use and medicine, particularly to a lotion pump with an externally installed spring.

### BACKGROUND ART

The lotion pumps have already been widely used in the industries of chemical articles for daily use and medicine. In the prior art, the lotion pumps, such as those disclosed in CN99207292.1 and CN01221317.9, the return spring is usually arranged axially between the piston and the housing, which makes the spring contact the lotion, thereby the problems that the spring will be corroded by the lotion and the corroded spring will then pollute the lotion will occur.

In order to overcome the above problems, some lotion pumps with an externally installed spring have been developed before the present invention, such as those disclosed in U.S. Pat. No. 4,371,097 and CN00133410.7 etc. However, such lotion pumps with externally installed springs have the drawbacks of complex structure and too many parts etc. The externally installed spring is usually placed in the “neck portion” under the nozzle head. Therefore, it makes the lotion pump and the neck portion of the bottle for holding the pump become very large in diameter, which changes the conventional aesthetic size ratio and impairs the appearance of the whole product. In addition, some externally installed springs, which are placed in the “neck portion”, require a higher mouth of bottle to be engaged, which impairs the versatility of the product.

### SUMMARY OF THE INVENTION

In order to overcome the above drawbacks, the object of the present invention is to provide a lotion pump with an externally installed spring, featuring a simple structure, less parts and unimpaired appearance.

In order to realize the above object, the present invention provides a lotion pump, comprises: a nozzle head; a connecting/guiding member connected to the nozzle head, in which an upper one-way valve is disposed; a container cap having a first connection structure and a second connection structure, the first connection structure is to engage with a mouth of a bottle; a housing, on its upper end, there is a connection structure engaging with the second connection structure on the container cap, and on its lower end, there is a lower one-way valve; a piston which moves within the housing, its upper end is connected to the connecting/guiding member; and a spring which makes the piston return; characterized in that, the upper end of the spring abuts against the connecting/guiding member, the lower end of the spring abuts against a spring seat which is provided in the housing.

Preferably, the diameter of the housing is reduced from its middle portion, thereby a step is formed on the inner wall of the housing, the step constitutes the spring seat in the housing, the piston slidingly moves in the small diameter portion.

Preferably, the spring is a spring having varying diameters, a diameter at its lower end is larger.

Preferably, the spring seat is an independent spring seat disposed in the housing.

Preferably, there is an inner ring in the container cap, on the inner ring, there is any one of at least one guiding groove and at least one guiding block, on the connecting/guiding member there is the other one of at least one guiding groove and at least one guiding block.

Preferably, the guiding groove and the guiding block constitute a lower-position locking mechanism, and on a lower surface of the inner side of the container cap and on an upper surface of the guiding block there is an engagement means for making them engage with each other.

Preferably, one side of the lower portion of the guiding groove is in an arc shape, and on the other side there is a protrusion to limit the rotation range of the guiding block and to prevent the guiding block from sliding back to the guiding groove.

Preferably, the container cap includes an end cover and a container cap body, which are connected to each other, the guiding groove and the guiding block further constitute an upper-position locking mechanism, on a lower surface of the end cover and an upper surface of the guiding block there is an engagement means for making them engage with other.

Preferably, on one side of the upper portion of the guiding groove there is a protrusion, which cooperates with the end cover to limit the range of rotation of the guiding block and to prevent the guiding block from sliding back to the guiding groove.

Preferably, on the lower portion of the housing there is a protruding inner pipe, an annular space is formed between an outer pipe of the housing and the protruding inner pipe, the annular space constitutes a spring seat in the housing, and the piston is in a sliding fit in the protruding inner pipe.

Preferably, there is any one of a sealing ring and a sealing plug on any one of the lower portion of the housing and the lower portion of the piston, and on the other one of the lower portion of the housing and the lower portion of the piston there is the other one of the sealing ring and the sealing plug, the sealing ring and sealing plug reach a seal by means of engaging with each other.

Preferably, the container cap includes an end cover and a container cap body, which are connected to each other, on the upper portion of the end cover a waterproof ring is disposed, the waterproof ring slidingly engages with the connecting/guiding member, thereby forming a seal when the nozzle head is locked.

By means of the lotion pump with an externally installed spring of the present invention, the spring will not contact the lotion, thereby preventing the spring from corrosion by the lotion and then preventing the lotion from pollution by the corroded spring. It is important that the lotion pump of the present invention is realized with a very simple structure, less parts (only five even four injection-molded parts), and hence the productivity can be notably raised and the manufacturing cost can be reduced. In addition, due to the fact that the spring is disposed in the housing and not in the “neck portion” of the bottle, the appearance of the product will not be impaired, and the height of the bottle mouth does not need to be increased.

In the following, the present invention will be described in conjunction with the accompanying drawings so that the objects, features and advantages of the present invention will be better understood.

### BRIEF DESCRIPTION OF THE DRAWINGS

FIG. 1 is a sectional view of the lotion pump with an externally installed spring according to the first embodiment of the present invention, in which the nozzle head is pressed down so that it is in a locked state;

FIG. 2 is a sectional view of the lotion pump with an externally installed spring according to the first embodiment of the present invention, in which the nozzle head is returned by the spring so that it is in a non-locked state;

FIG. 3 is an exploded sectional view of the above-mentioned lotion pump with an externally installed spring;

FIG. 4a and 4b are respectively a bottom views and a sectional view of the nozzle head;

FIG. 5a and 5b are respectively a bottom view and a sectional view of the container cap, while FIG. 5c is a view developed along φ A of FIG. 5b;

FIG. 6a, 6b and 6c are respectively a bottom view, a sectional view and a top view of the connecting/guiding member;

FIG. 7a, 7b, 7c are respectively a sectional view, a front view and a top vertical view of the piston;

FIG. 8 is a front view of the return spring;

FIG. 9a and 9b are respectively a sectional view and a top view of a gasket;

FIG. 10a, 10b, 10c, 10d are respectively a bottom view, a front view, a sectional view and a top view of the housing;

FIG. 11 is a sectional view showing the second embodiment of the lotion pump with an externally installed spring according to the present invention, in which the nozzle head is pressed down and is in a locked state;

FIG. 12 is a sectional view showing the second embodiment of the lotion pump with an externally installed spring according to the present invention, in which the nozzle head is returned by the spring so that it is in a non-locked state;

FIG. 13 is an exploded sectional view of the above-mentioned lotion pump with externally installed spring;

FIG. 14a and 14b are respectively a bottom view and a sectional view of the nozzle head;

FIG. 15a and 15b are respectively a bottom view and a sectional view of the container cap;

FIG. 16a and 16b are respectively a sectional view and a top view of the connecting/guiding member;

FIG. 17a, 17b and 17c are respectively a sectional view, a front view and a bottom view of the piston;

FIG. 18 is a front view of the return spring;

FIG. 19a and 19b are respectively a sectional view and a bottom view of the gasket;

FIG. 20a, 20b, 20c and 20d are respectively a bottom view, a front view, a sectional view and a top view of the housing;

FIG. 21 is a sectional view of the third embodiment of the lotion pump with an externally installed spring of the present invention, in which a nozzle head is pressed down so that it is in a locked state;

FIG. 22 is the sectional view of the third embodiment of the lotion pump with externally installed spring according to the present invention, in which the nozzle head is returned by the spring so that it is in a non-locked state;

FIG. 23 is an exploded sectional view of the above-mentioned lotion pump with an externally installed spring;

FIG. 24a and 24b are respectively a bottom view and a sectional view of the nozzle head;

FIG. 25a and FIG. 25b are respectively a bottom view and a sectional view of the end cover;

FIG. 26a, 26b are respectively a bottom view and a sectional view of the container cap. while FIG. 26c is a developed view along φ A of FIG. 26b;

FIG. 27a, 27b are respectively a sectional view and a top vertical view of the connecting/guiding member;

FIG. 28a, 28b are respectively a bottom view and a sectional view of the spring seat;

FIG. 29a, 29b, 29c are respectively a front view, a sectional view and a top view of the piston seal;

FIG. 30a, 30b, 30c are respectively a section view, a front view and a top view of the piston;

FIG. 31a, 31b are respectively a sectional view and a bottom view of the gasket;

FIG. 32 is a front view of the return spring; and

FIG. 33a, 33b, 33c and 33d are respectively a bottom view, a front view, a sectional view and a top view of the housing.

### EMBODIMENTS

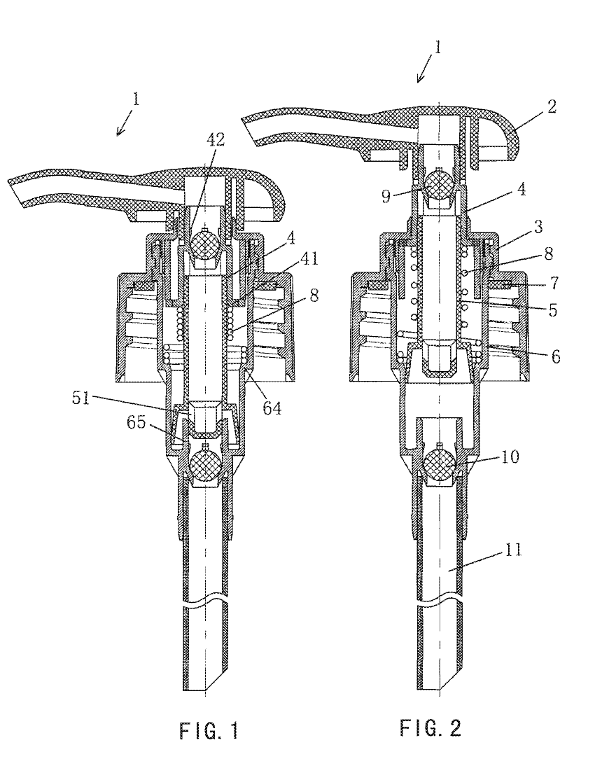

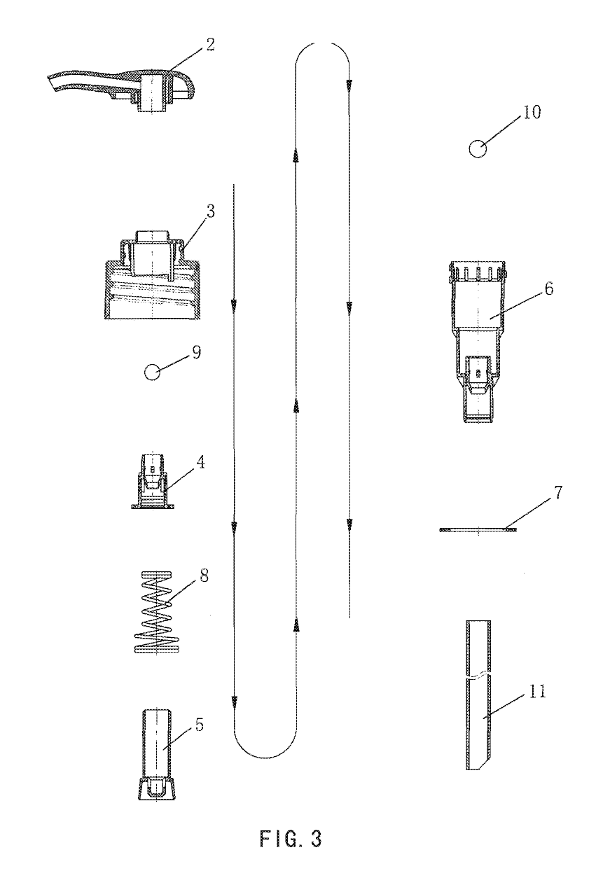

Please refer to FIG. 1-FIG. 10, in which is shown the lotion pump with an externally installed spring according to the first embodiment of the present invention, in which the lotion pump is indicated by a numeral 1. As shown in FIGS. 1-3, the lotion pump with an externally installed spring 1 mainly includes a nozzle head 2, a container cap 3, a connecting/guiding member 4, a piston 5, a housing 6, a gasket 7, a return spring 8, an upper ball 9, a lower ball 10 and a sucking pipe 11.

The basic principle of the lotion pump is similar to the prior art. In particular, the upper ball 9 and the valve seat 43 on the connecting/guiding member 4 constitute an upper one-way valve, the lower ball 10 and the valve seat 63 on the housing 6 constitute a lower one-way valve. When the nozzle head 2 is pressed downwardly, the upper one-way valve opens and the lower one-way valve closes, thereby the lotion in the pump chamber is pumped out. When the nozzle head 2 moves upwardly, the upper one-way valve closes and the lower one-way valve opens, thereby the lotion in the bottle is sucked into the pump chamber through the sucking pipe 11.

FIG. 1 shows that the nozzle head 2 is pressed downwardly to be in a locked state or position. The “locked state or position” means that the nozzle head 2 is locked and in a state unable to pump lotion out. In this state, the product is easy to be transported and stored. FIG. 2 shows that the nozzle head 2 is returned or restored by the spring 8 and is a non-locked state, in which the lotion pump can be used to pump lotion.

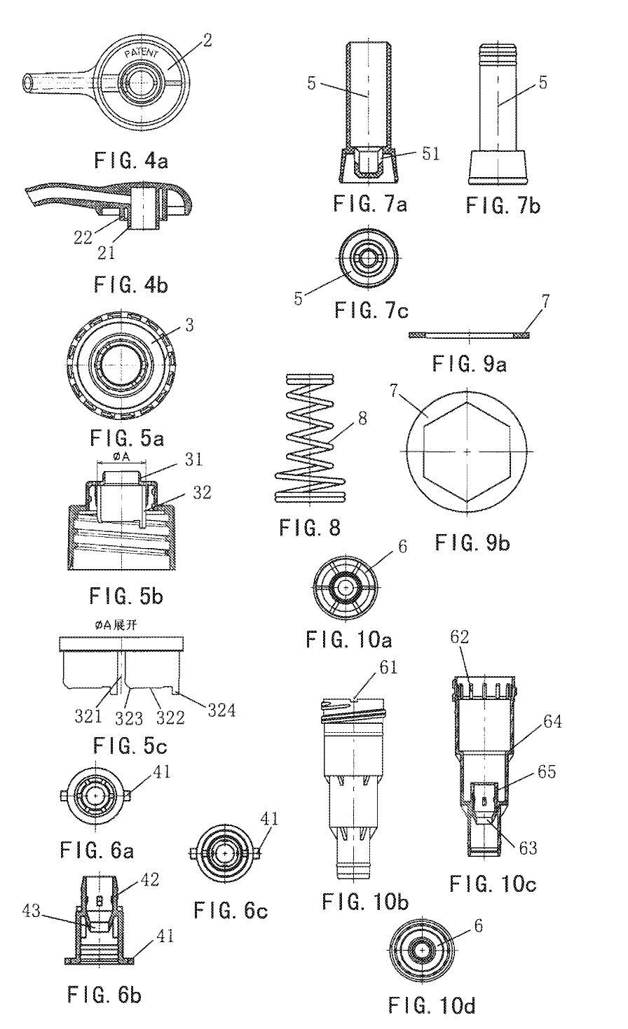

As shown in FIG. 1 and FIG. 2, the nozzle head 2 is connected to the connecting/guiding pipe 4. As shown in FIG. 4a and FIG. 4b, the nozzle head 2 has no complicated screw thread structure, it has an inner pipe 21 and an outer pipe 22 downwardly and concentrically arranged, an annular recess is formed between the inner pipe 21 and outer pipe 22. The inner pipe 21 is engaged with the connecting/guiding member 4, and between them, a structure, such as a concave-convex structure, for preventing them from rotating relatively can be arranged. The annular recess between the inner pipe 21 and outer pipe 22 can receive a waterproof sealing ring 31 of the container cap 3 when in the locked position.

The first connection structure on the lower portion of container cap 3 (in this embodiment it is an inner screw thread, but a non-helical concave-convex structure or other connection structure such as connection teeth can also be used) can be engaged with the bottle mouth to guarantee the sealing with the bottle mouth by means of the gasket 7 on the top of the container cap. The second connection structure on the upper portion of the container cap 3 (thread, concave-convex structure or other connection structures) is engaged with the corresponding connection structure on the upper end portion of the housing 6. As shown in FIG. 5b, on the upper portion of the container cap 3 is disposed a waterproof sealing ring 31 to prevent water from flowing into the lotion pump and then into the bottle, and to constitute a seal with the nozzle head 2 when in the locked position (FIG. 1). An inner ring 32 is disposed in the container cap 3, and at least one guiding groove 32] is provided on the inner ring. As shown in FIGS. 6a-6c, at least one guiding block 41 is provided on the lower portion of the connecting/guiding member 4. The number of the guiding block may be one, two or even more, and it will be preferred if they are concentrically disposed with the same central angle. The guiding groove 321 may be engaged with the guiding block 41 on the connecting/guiding pipe 4 (see FIG. 6a-6b) to form a lower-position locking mechanism. When the guiding block 41 moves up and down in the guiding groove 321, the lotion pump is in a state of operation (FIG. 2). When the nozzle head 2 is pressed to the lower stop point, and rotated in clockwise, the pump is in the lower-position locked state (FIG. 1). As shown in FIG. 1, FIG. 5b, FIG. 5c, the guiding groove has a notch. The “notch” means that it is formed by completely passing through the whole wall thickness. When the nozzle head is locked, the upper surface of the guiding block 41 will stop at the lower portion of the horizontal part of the whole thickness of the wall. Adopting such a “notch” structure, which passes through the whole wall thickness, can save the raw material, and because the contacting area between the guiding block and the wall thickness is larger, the engagement strength can be improved.

In addition, the guiding groove 321 may also be in the form of a recess. The “recess” means that it does not need to pass through the whole wall thickness, instead only a portion of the wall thickness need to be recessed from the wall thickness. In this case, when the nozzle head is locked, the upper surface of the guiding block 41 can be stopped when engaged with a portion of a lower surface 322 of the inner ring 32.

As shown in FIG. 5c, one side of the lower portion of the guiding groove 321 is in an arc shape so that the guiding block 41 can slide easily out of the notch. In addition, a small protruding portion 323 in an arc shape is provided to prevent the guiding block 41 from sliding back to the notch. The other side of the lower portion of the guiding groove 321 has a protrusion 324 to limit the rotation of the guiding block 41, thereby the theoretical nozzle head locking angle may reach 0°-180°. Preferably, on the lower surface 322 of the inner ring 32 and on the upper surface of the guiding block 41, an engagement means is provided to make them engage with each other. The engagement means, for example, may be two sets of linear protruding strips, which preferably are concentrically and radially arranged with the same central angle, and corresponded to each other. After the nozzle head has been adjusted to a desired direction, the engagement means (the two sets of protruding strips) can keep the nozzle head in this direction and make it not easy to move. The engagement means may also have some other forms, for example, an engagement structure in which a knife edge or blade is disposed on the upper surface of the guiding block 41.

In addition, as shown in FIG. 1 and FIG. 2, in the inner hole of the upper portion of the connecting/guiding member 4 are disposed a valve seat 43 and an upper ball 9, both of which comprise the upper one-way valve. On the inner wall above the upper ball 9 are disposed two or more position limiting pieces 42. The inner hole formed by the position limiting pieces 42 is slightly smaller than the diameter of the upper ball 9, so that, when pressed downwardly by a force, the upper ball 9 can drop onto the valve seat 43, but during the operation, the upper ball is stopped by the position limiting pieces 42 and cannot pass through the position limiting pieces to go upwardly,

The upper end of the piston 5 is connected to the connecting/guiding member 4, and moves linearly within the housing 6 following the movement of the nozzle head 2 and the connecting/guiding member 4.

As shown in FIG. I and FIG. 2, the upper end of the housing 6 is connected with the container cap 3 by means of screw threads. Preferably, some small air grooves are disposed in the screw threads of the upper end of the housing 6. One or more notches 61 are provided on the upper end face of the housing 6. As shown in FIG. 10c, a plurality of longitudinal protruding strips 62 are provided on the inner side of the upper end of the housing 6, and similar producing strips are provided on the outer side of the inner ring 32 of the container cap 3. When the housing 6 is screwed into the container cap 3, the two sets of protruding strips make the housing 6 to be coaxially positioned relative to the container cap 3, and prevent them from loosing while providing clearance as air passage. The above-mentioned air grooves in the screw thread, the notch on the upper edge of the housing and the protruding strips are all better structures for aeration.

It is important that the housing 6 reduce its diameter from its middle portion, thereby forming a step 64 on its inner wall for receiving a spring 8. The step 64 constitutes a spring seat. The lower end of the spring 8 abuts against the step 64 in housing 6, and the upper end of the spring 8 abuts against the lower end of the connecting/guiding member 4. Therefore, the spring 8 is disposed in the upper half of the housing 6, and cannot be wetted by the lotion. In the embodiment, it is preferable to use a spring with varying diameters. That is, the diameter in the lower portion of the spring is larger. The whole spring is mounted around the piston 5.

The inner wall of the small diameter portion of the housing 6 cooperates with the piston 5. A sealing ring 65 is extended upwardly from the lower ball hole in the lower portion of the housing 6, and a sealing plug 51 is extending downwardly from the lower portion of the piston 5. When the nozzle head is locked, the sealing plug 51 of the piston 5 engages with the sealing ring 65 of the housing 6 to reach a seal, thereby ensuring that the lotion will not leak from the nozzle. More than one through holes are formed between the piston 5 and its sealing plug 51 to form the passageway for the lotion. Of course, the position of the sealing plug of the piston 5 and that of the sealing ring of the housing 6 are interchangeable, the same object can be realized by doing so.

In addition, as shown in FIG. 1 and FIG. 2, in the inner hole in the lower portion of the housing 6, the valve seat 63 and the lower ball 10, which constitutes the lower one-way valve, are provided. A sucking pipe 11 is disposed on the lower end portion of the housing 6 and is communicated with the bottom of the bottle.

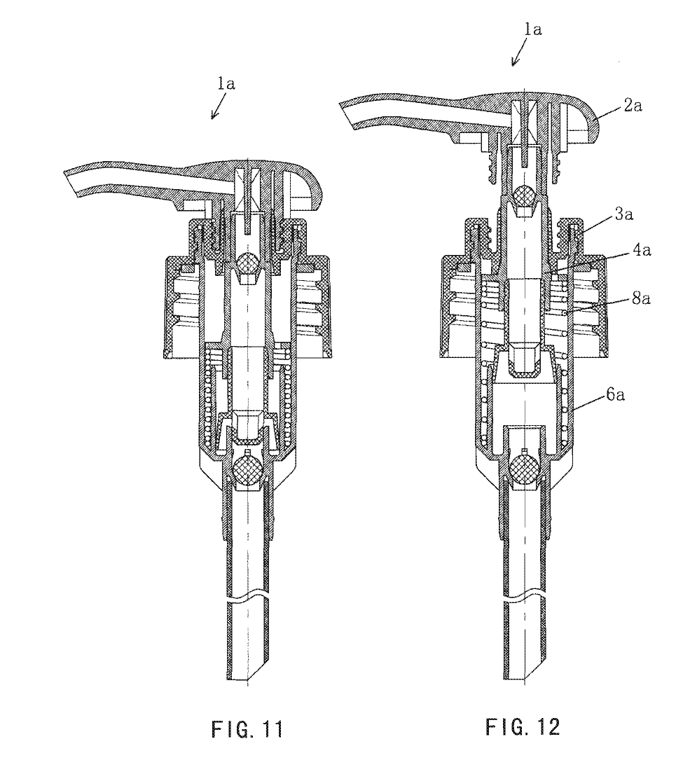

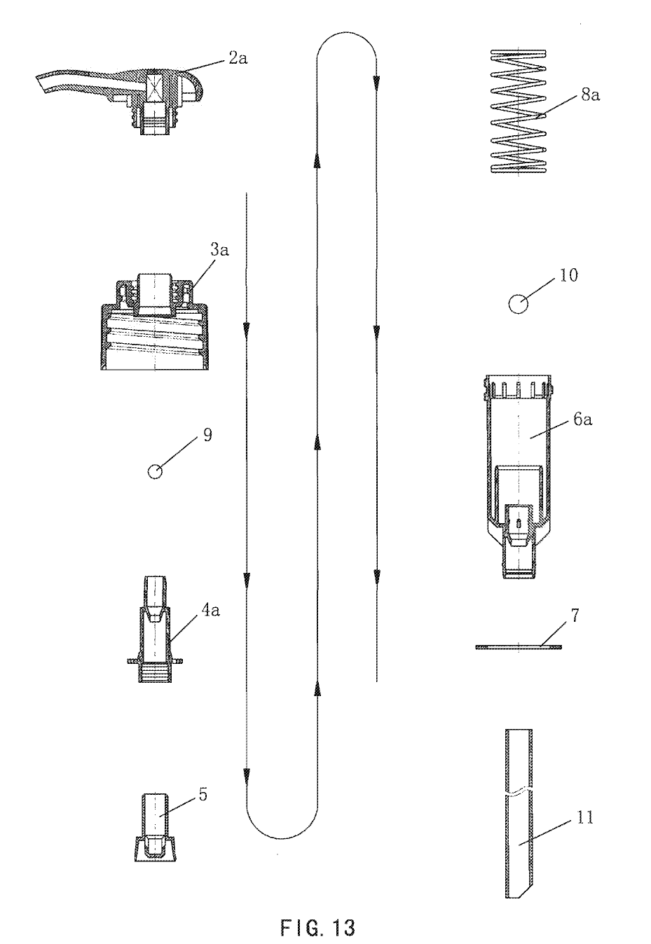

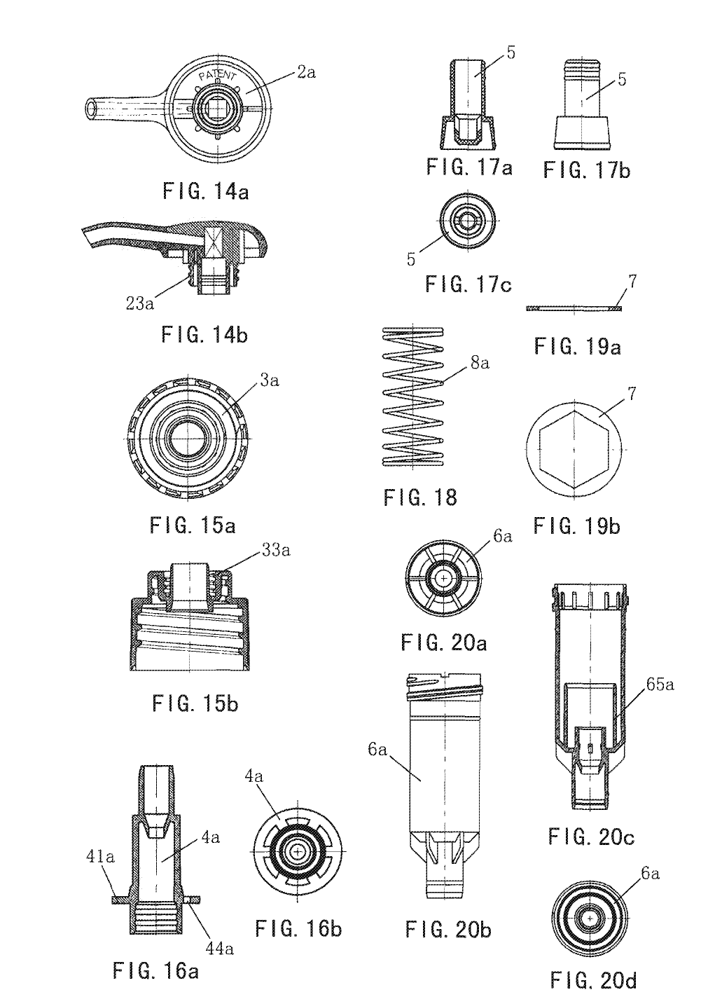

In the following, the lotion pump with an externally installed spring according to the second embodiment of the present invention will be described in conjunction with FIG. 11-FIG. 20. The lotion pump is indicated by a numeral 1a. In the following descriptions, the parts of the lotion pump 1a, which are identical to or similar to those of the first embodiment, will be indicated by the same numerals as in the first embodiment, and will not be given unnecessary details, If the parts have some differences from those of the first embodiment, a suffix “a” will be added thereto.

As shown in FIG. 11-FIG. 13, the lotion pump I a with an externally installed spring mainly includes a nozzle head 2a, a container cap 3a, a connecting/guiding pipe 4a, a piston 5, a housing 6a, a gasket 7, a return spring 8a, an upper ball 9, a lower ball 10 and a sucking pipe 11. The basic operation principle of the lotion pump 1a is also similar to the prior art, and hence unnecessary details will not be given.

As shown in FIG. 11 and FIG. 12, the nozzle head 2a is also connected to the connecting/guiding member 4a. The difference between the nozzle head 2a and the nozzle head 2 in first embodiment lies in that, the nozzle head 2a uses a screw thread structure to achieve the nozzle head locking. As shown in FIG. 14a and FIG. 14b, there is an outer screw thread 23a on the lower end of the nozzle head 2a. The outer screw thread 23a can engage with the inner screw thread 33a on the neck portion of the container cap 3a to lock the nozzle head. FIG. 11 shows that the nozzle head 2a is pressed down and is in the locked position.

Correspondingly, the difference between the container cap 3a and the container cap 3 of the first embodiment lies in that, there is an inner screw thread 33a on its neck position in order to engage with the outer screw thread 23a on the nozzle head 2a. It should be understood that the inner and outer screw threads on the nozzle head and the container cap are interchangeable.

As shown in FIGS. 16a and 16b, the difference between the connecting/guiding member 4a and the connecting/guiding member 4 of the first embodiment lies in that, the connecting/guiding member 4a has a spring blocking ring 41a, and there is an air passing hole 44a on the spring blocking ring 41a.

As shown in FIG. 11 and FIG. 12, the difference between the housing 6a and the housing 6 of the first embodiment lies in that, there is an protruding inner pipe 65a on the lower portion of the housing 6a, and an annular space is formed between the outer pipe of the housing 6a and the protruding inner pipe 65a. The annular space also forms a spring seat. The piston 5 can slide in the protruding inner pipe 65a.

In this embodiment, a conventional spring 8a can be used, its lower end is disposed in the annular space and its upper end abuts against the spring blocking ring 41a of the connecting/guiding member 4. This arrangement prevents the spring 8 from contacting the lotion. The size of the neck portion of the bottle does not need to be increased, and the number of the parts will not be increased.

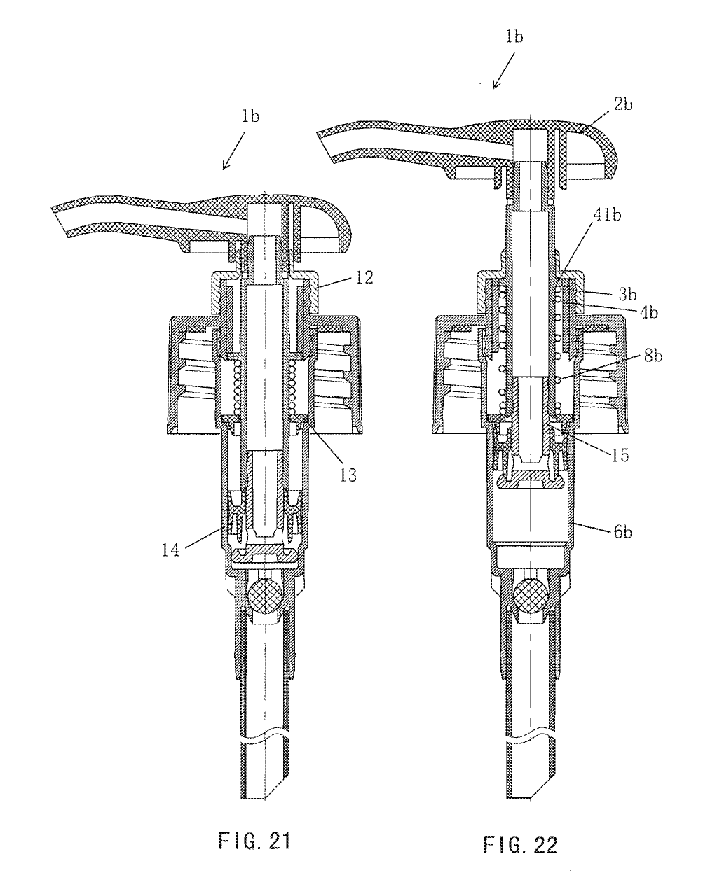

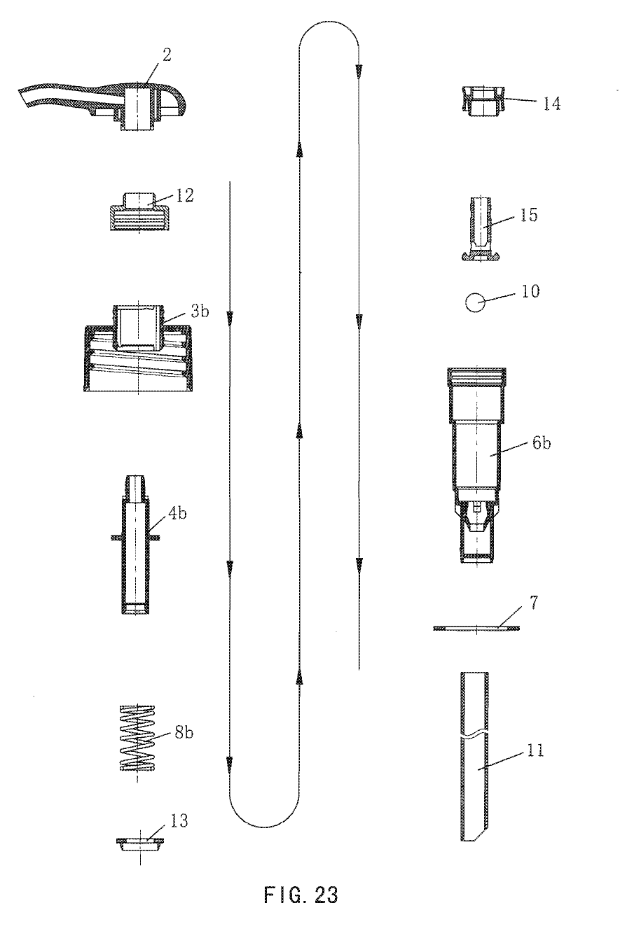

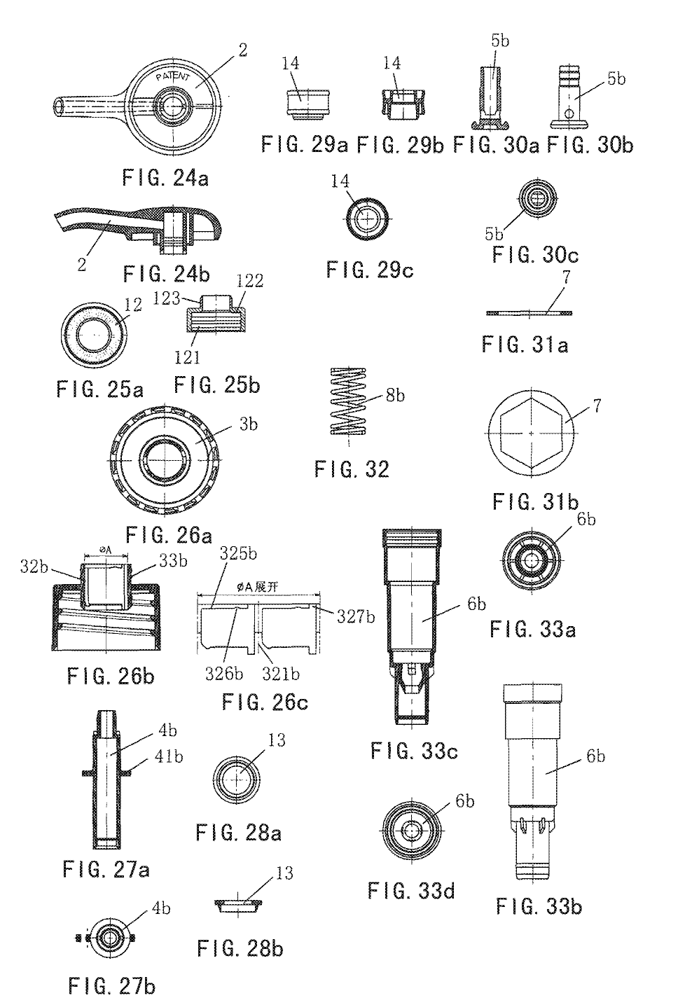

In the following, the lotion pump with an externally installed spring according to the third embodiment of present invention will be described in conjunction with FIG. 21-FIG. 33. The lotion pump is indicated by a numeral 1b. In the following descriptions, the parts of the lotion pump 1b, which are identical to or similar to those of the first embodiment, will be indicated by the same numerals as those in the first embodiment, and will not be given unnecessary details. For the parts with some differences from those in the first embodiment, a suffix “b” will be added thereto.

As shown in FIGS. 21-23, the lotion pump 1b with an externally installed spring is used for the materials with high viscosity. It mainly includes a nozzle head 2b, an end cover 12, a container cap body 3b, a connecting/guiding member 4b, a spring 8b, a spring seat 13, a piston seal 14, a piston 15, a lower ball 10, a housing 6b, a gasket 7 and a sucking pipe 11.

The basic operation principle of the lotion pump 1b is similar to the existing pump for high viscosity materials. When the nozzle head 2b is pressed down, the piston 15 moves downwardly, the piston seal 14 will separate from the piston 15 due to the friction force with the inner wall of the housing 6b, thereby the lotion will be pumped out from the nozzle head. When the nozzle head 2b is released, under the action of the spring 8b, the piston 14 will move upwardly following the piston 15, and due to the friction force between the piston seal 14 and the housing 6b, the piston 14 will be pressed onto the piston seal 15 forming a forced sealing. This will produce a negative pressure, making the lower ball 10 separate from the valve seat, and hence the lotion will be sucked from lotion container through the sucking pipe 11 for use in the next press operation.

In this embodiment, the container cap is divided into an end cover 12 and a container cap body 3b. On the inner periphery of the end cover 12, there are concaves 121 and on the outer periphery of the container cap body 36 there are convexes 33b. Through the engagement between the concaves 121 and the convexes 33b, the end cover 12 will be connected with the container cap body 3b. On the end cover 12 there is a waterproof sealing ring 123, which is in a sliding engagement with the connecting/guiding member, thereby forming a seal when the nozzle head is locked.

As shown in FIGS. 26a to 26c, in the third embodiment, both a lower-position locking mechanism and an upper-position locking mechanisms are used, in which the lower-position locking mechanism is basically similar to the structure as described in the first embodiment, but as shown in the figures, in the third embodiment the “recess” mentioned in the first embodiment is used in place of the “notch” passing through the whole wall thickness.

In the following, the upper-position locking mechanism will be described in conjunction with FIGS. 21-22 and FIGS. 25-27. Again, it involves the guiding block(s) 41b of the connecting/guiding member 4b and the guiding groove(s) 321b on the container cap body 3b. As shown in FIG. 22, after the nozzle head 2b moves up along the guiding groove 321b to the upper stop point and then is rotated, it will in an upper-position locked state. At this time, the guiding block 41 is stopped and is sandwiched between the end cover 12 and the upper surface 325b of the inner ring. Preferably, a small protruding portion 326b can be disposed on the upper surface 325b of the inner ring to limit the rotation of the guiding block 41b. On one side of the upper portion of the guiding groove, there is a protruding block 327b being provided to limit the rotation of the guiding block, thereby limiting the locking angle of the nozzle head.

In addition, it is preferable that, between the lower surface 122 of the inner side of the container cap (in this embodiment, the separated end cover 12) and the upper surface of the guiding block 41b, there is an engagement means, such as two sets of linear protruding strips, to make them engage with each other. Preferably, such protruding strips correspond with each other, and are radially and concentrically arranged with the same central angle. When the nozzle head 2b is adjusted to an desired direction, the engagement means (the two sets of protruding strips) keeps the nozzle head in this direction and makes it not easy to move. The other type of engagement means can also be used, for example, two sets of protruding strips can be arranged between the upper surface of the inner ring 32b and the lower surface of the guiding block 41b.

Further, it is important that an independent spring seat 13 be presented in this embodiment. The spring seat abuts against the inner wall step of the housing 6b. The lower end of the spring 8b abuts against the spring seat 13, while the upper end of the spring 8b abuts against the protruding edge 41b of the connecting/guiding member 4b. Therefore, the spring 8b is also disposed in the upper half of the housing 6 without being wetted by the lotion. In this embodiment, it is unnecessary to use a spring with varying diameters. In other words, it is unnecessary to use a spring with a large upper portion and a small lower portion.

Although the present invention is described in details in conjunction with several embodiments, it should be understood that the persons skilled in this art can make various equivalent variants and modifications on the basis of the disclosed content. For example, the positions of the locking structures in the first and second embodiments are interchangeable, that is, the guiding block can be disposed on the connecting/guiding member while the guiding groove can be disposed on container cap, or the guiding block can be disposed on the container cap while the guiding groove is disposed on the plunger; the connecting/guiding member may be integrated with the piston; the various structures of screw thread connection, the female and male screws connections may be interchanged. Therefore, the protection scope of this application should be defined by the appended claims,

1. A lotion pump, comprises: a nozzle head; a connecting/guiding member connected to the nozzle head, in which an upper one-way valve is disposed; a container cap having a first connection structure and a second connection structure, said first connection structure is to engage with a mouth of a bottle; a housing, on its upper end, there is a connection structure engaging with the second connection structure on the container cap, and on its lower end, there is a lower one-way valve; a piston which moves within the housing, its upper end is connected to the connecting/guiding member; and a spring which makes the piston return; characterized in that, the upper end of the spring abuts against the connecting/guiding member, the lower end of the spring abuts against a spring seat which is provided in the housing,
wherein the diameter of said housing is reduced from its middle portion, thereby a step is formed on the inner wail of the housing, said step constitutes the spring seat in the housing, said piston slidingly moves in the small diameter portion.

2. (canceled)

3. The lotion pump according to claim 1, wherein said spring is a spring having varying diameters, a diameter at its lower end is larger.

4. (canceled)

5. The lotion pump according to claim 1, wherein there is an inner ring in the container cap, on said inner ring, there is any one of at least one guiding groove and at least one guiding block, on said connecting/guiding member there is the other one of at least one guiding groove and at least one guiding block.

6. The lotion pump according to claim 5, wherein the guiding groove and the guiding block constitute a lower-position locking mechanism, and on a lower surface of the inner side of the container cap and on an upper surface of the guiding block there is an engagement means for making them engage with each other.

7. The lotion pump according to claim 6, wherein one side of the lower portion of the guiding groove is in an arc shape, and on the other side there is a protrusion to limit the rotation range of the guiding block and to prevent the guiding block from sliding back to the guiding groove.

8. The lotion pump according to claim 5, wherein the container cap includes an end cover and a container cap body, which are connected to each other, said guiding groove and said guiding block further constitute an upper-position locking mechanism, on a lower surface of said end cover and an upper surface of the guiding block there is an engagement means for making them engage with other.

9. The lotion pump according to claim 8, wherein on one side of the upper portion of the guiding groove there is a protrusion which cooperates with the end cover to limit the range of rotation of the guiding block and to prevent the guiding block from sliding back to the guiding groove.

10. (canceled)

11. The lotion pump according to claim 1, wherein there is any one of a sealing ring and a sealing plug on any one of the lower portion of the housing and the lower portion of the piston, and on the other one of the lower portion of the housing and the lower portion of the piston there is the other one of the sealing ring and the sealing plug, said sealing ring and sealing plug reach a seal by means of engaging with each other.

12. The lotion pump according to claim 1, wherein said container cap includes an end cover and a container cap body, which are connected to each other, on the upper portion of the end cover a waterproof ring is disposed, said waterproof ring slidingly engages with the connecting/guiding member, thereby forming a seal when the nozzle head is locked.

13. A lotion pump, comprises: a nozzle head; a connecting/guiding member connected to the nozzle head, in which an upper one-way valve is disposed; a container cap having a first connection structure and a second connection structure, said first connection structure is to engage with a mouth of a bottle; a housing, on its upper end, there is a connection structure engaging with the second connection structure on the container cap, and on its lower end, there is a lower one-way valve; a piston which moves within the housing, its upper end is connected to the connecting/guiding member; and a spring which makes the piston return; characterized in that, the upper end of the spring abuts against the connecting/guiding member, the lower end of the spring abuts against a spring seat which is provided in the housing, wherein on the lower portion of the housing there is a protruding inner pipe, an annular space is formed between an outer pipe of the housing and the protruding inner pipe, said annular space constitutes a spring seat in the housing, and said piston is in a sliding fit in the protruding inner pipe.

14. The lotion pump according to claim 13, wherein there is an inner ring in the container cap, on said inner ring, there is any one of at least one guiding groove and at least one guiding block, on said connecting/guiding member there is the other one of at least one guiding groove and at least one guiding block.

15. The lotion pump according to claim 13, wherein there is any one of a sealing ring and a sealing plug on any one of the lower portion of the housing and the lower portion of the piston, and on the other one of the lower portion of the housing and the lower portion of the piston there is the other one of the sealing ring and the sealing plug, said sealing ring and sealing plug reach a seal by means of engaging with each other.

16. The lotion pump according to claim 13, wherein said container cap includes an end cover and a container cap body, which are connected to each other, on the upper portion of the end cover a waterproof ring is disposed, said waterproof ring slidingly engages with the connecting/guiding member, thereby forming a seal when the nozzle head is locked.
